(19) United States
(12) Patent Application Publication
(10) Pub. No.: US 2012/0124441 A1
(43) Pub. Date: May 17, 2012

(54) EMBEDDED TESTING MODULE AND TESTING METHOD THEREOF

(75) Inventors: LI-MING TENG, Hsinchu City (TW); YU-TSAO HSING, Hsinchu City (TW)

(73) Assignee: HOY TECHNOLOGIES CO, Hsinchu City (TW)

(21) Appl. No.: 12/984,988

(22) Filed: Jan. 5, 2011

(30) Foreign Application Priority Data
Nov. 17, 2010 (TW) 099139544

(51) Int. Cl. G06F 11/263

(52) U.S. Cl. 714/735; 714/E11.177

(57) ABSTRACT

The present invention discloses an embedded testing module and testing method thereof which encodes one or more test commands to reduce the storage space required by a testing memory. In addition, most functions of automatic test equipment can be replaced by the present invention, in which, through the testing memory according to the present invention, if errors are found during testing, the error information will be transmitted to the external automatic test equipment and the error information can be optionally recorded in a memory. A test operator can get detailed descriptions from the error information stored in the memory, so the test operator can save time for subsequent debugging and tracking operations concerning the errors.

### BACKGROUND OF THE INVENTION

1. Field of the Invention

The present invention relates to an embedded testing module and testing mode thereof; in particular, the present invention relates to an embedded testing module and testing mode thereof applicable for testing a Non-Volatile Memory (NVM).

2. Description of Related Art

The creation of integrated circuits (ICs) has significantly changed human life styles and become closely related with national economic activities, technical innovations as well as enterprise developments. With incessant progressions and renovations in relevant technical industries, new consumer electronic devices extended from the architecture of IC also keep evolving with improvements; in such a type of electronic devices, the central processing unit (CPU) definitely plays a critical role among various internal components, and the memory for data storage is one of numerous indispensible components as well.

Based on the functionality and application field thereof, the memory can be further differentiated into several categories, generally including Static Random Access Memory (SRAM), Dynamic Random Access Memory (DRAM), Read-only Memory (ROM) and FLASH etc., which is essentially used to store programs and data thereby preventing losses of required data which may lead to erroneous operations of the electronic device; and in addition, as data process amounts consistently increasing, the capacity and the number of memory units installed inside the electronic device also accordingly scale up, so the conditioning and testing on memory operations become momentous, too.

In addition to fundamental operating modes for the conventional Non-Volatile Memory (NVM), such as read, program, clear and the like, along with advancement in memory technologies, many new NVM types and operating modes therefore have been derivatively developed, e.g., operating under various environment settings with regards to different voltages, different frequencies etc. Testing engineers can assemble several test commands into an integral test flow, and a prior art Automatic Test Equipment (ATE) can receive the input of such test commands one by one thereby constructing a set of complete test flow; however, this approach may undesirably increase the complexity in controls and communications between the memory under test and the external ATE and require longer testing time.

Afterward, to improve the disadvantage in respective input of test command, the prior art was designed to dispose an embedded Built-In Self-Test (BIST) circuit in the memory under test so as to perform read/write actions on the memory under test through the built-in test algorithm of the testing circuit; whereas, although this approach can reduce the complexity of communications with the external ATE, since the memory technology continues to evolve along with increasingly wider application fields, to ensure normal and stable operations of the memory in a product, it is not enough to simply depend on the test algorithm to achieve the required fault coverage, but needs to modify the test parameters for different test considerations at the test stage, and to additionally include corresponding test commands in the test flow when operating the ATE. Unfortunately, the test algorithm utilized in prior art can merely employ and further rearrange the aforementioned fundamental operating modes, and the test item is restricted to the function test, thus incapable of effectively extending the fault coverage and shortening the entire test time.

Besides, upon detection of any data error in the memory by the prior art embedded BIST circuit, the test flow will nonetheless be completed; hence, such a technical action may futilely elongate the test time, and the test operator can not be provided with relevant information concerning the occurrence point as the error taking place, thus adversely elevating the difficulty in the debugging process for the test operator.

### SUMMARY OF THE INVENTION

In view of the above-said drawbacks, the objective of the present invention is to provide an embedded testing module and testing method thereof which allows to not only execute the function test but also encompass the parametric test, thereby substituting most functions in the conventional test equipment, reducing difficulty in debug operations for test operators and shortening time for memory tests.

As such, to achieve the aforementioned objectives, the embedded testing module according to the present invention comprises: a connection port, a memory and a testing unit. The memory is used to store a first data and electrically connected to the connection port, in which the memory is tested based on the first data thereby forming a second data, and transfers the second data through the connection port. Besides, the testing unit executes a test command or another test command to generate the first data and an expected data corresponding to the first data, wherein the testing unit transfers the first data to the memory by way of the connection port and receives the second data via the connection port thereby comparing with the expected data; in case that the second data does not match the expected data, an error information is immediately outputted to an external ATE. Herein the test command and another test command are encoded in a codeword so as to reduce the storage space required for saving the test command.

Additionally, the embedded testing module according to the present invention further comprises (not limited thereto) parameter generating and measuring units such as a temperature sensor, a frequency generator and a voltage regulator and so forth, wherein the frequency generator and the voltage regulator are electrically connected to the memory, the temperature sensor is electrically connected the testing unit, in which the temperature sensor detects the temperature in the memory, the testing unit sets the frequency of the frequency generator and the voltage of the voltage regulator based on the test command such that the memory operates under the assigned frequency and voltage. Herein, when the testing unit finds the occurrence of error in the memory during tests, the temperature, frequency, voltage and access time range of the memory can be stored in the memory and outputted to the ATE for categorizations and error analyses.

Moreover, the present invention further provides a testing method of the embedded testing module, comprising: providing a first data to the memory thereby executing test actions and generating a second data corresponding to the first data to a testing unit, in which the first data is converted into the test flow for the state of the test actions executable by the memory through the testing unit, and the test flow performs at least one codeword which consists of at least one test command. Subsequently, the method comprises generating an expected data corresponding to the first data and comparing the second data with the expected data by means of the testing unit, wherein in case that the second data matches the expected data, executing another test command until the test flow is completed and transferring the test result to an external ATE; while the second data differs from the expected data, directly aborting the test and transferring the error information for use of testing to the external ATE.

In addition, the present invention further provides a testing method of the embedded testing module, comprising: providing a first data to the memory thereby executing test actions and generating a second data corresponding to the first data to a testing unit, in which the first data is converted into the test flow for the state of the test actions executable by the memory through the testing unit, and the test flow performs at least one codeword which consists of at least one test command.

Next, the method comprises generating an expected data corresponding to the first data and comparing the second data with the expected data by means of the testing unit, wherein in case that the second data matches the expected data, executing another test command until the test flow is completed and transferring the test result to an external ATE; while the second data differs from the expected data, transferring the error information for use of testing to the external ATE for later error diagnoses and analyses by the test operator, and executing another test command until the test flow is completed.

Also, the present invention allows the user to configure, through test commands, whether to write the test result and error information into the memory at the end of the test flow, and the embedded testing module can automatically verify the accuracy of the data written in the memory.

In summary, the embedded testing module and testing mode thereof according to the present invention enables the following advantages:

1. the embedded testing module and testing mode thereof according to the present invention encodes at least one test command into a codeword, such that, when larger number of test commands are scheduled by a test operator, it is possible to reduce the register costs for test command storage by means of the embedded testing module and testing mode thereof according to the present invention;

2. upon finding by the testing unit that the second data mismatches the expected data, the error information can be generated immediately thereby facilitating the test operator to debug and select whether to interrupt the test earlier, which allows to save time for the test operator in comparison with prior art that needs to complete the entire test flow to appreciate if there exists any error;

3. the user can configure the working frequency and test function of the embedded testing module by way of test commands defined in the codeword, thus achieving the function of parametric test for the memory. Such memory parameters include the access time range of the memory, voltage and temperature. In the parametric test mode, when the embedded testing module detects occurrence of errors in the memory, it records test conditions such as frequency, voltage as well as temperature in the Non-Volatile Memory thereby facilitating subsequent follow-up processes by the user.

In order to further understand and appreciate the technical characteristics and achieved effects of the present invention, preferred embodiments of the present invention are provided as below in conjunction with detailed descriptions thereof.

### BRIEF DESCRIPTION OF THE DRAWINGS

FIG. 1 shows a first diagram for the embedded testing module according to the present invention.

FIG. 2 shows a second diagram for the embedded testing module according to the present invention.

FIG. 3 shows a diagram for the types of the memory under test which tested by the embedded testing module according to the present invention.

FIG. 4 shows a third diagram for the embedded testing module according to the present invention.

FIG. 5 shows a flowchart for a first embodiment of the testing method of the embedded testing module according to the present invention.

FIG. 6 shows a diagram for a conventional record test command.

FIG. 7 shows a diagram for a record test command according to the present invention.

FIG. 8 shows a flowchart for a second embodiment of the testing method of the embedded testing module according to the present invention.

### DETAILED DESCRIPTION OF THE PREFERRED EMBODIMENTS

Reference will now be made to relevant drawings of the present invention to illustrate the embedded testing module and testing mode thereof according to the present invention, and to facilitate better appreciations, identical components described in the following embodiments will be marked with the same numerals/symbols throughout the entire specification.

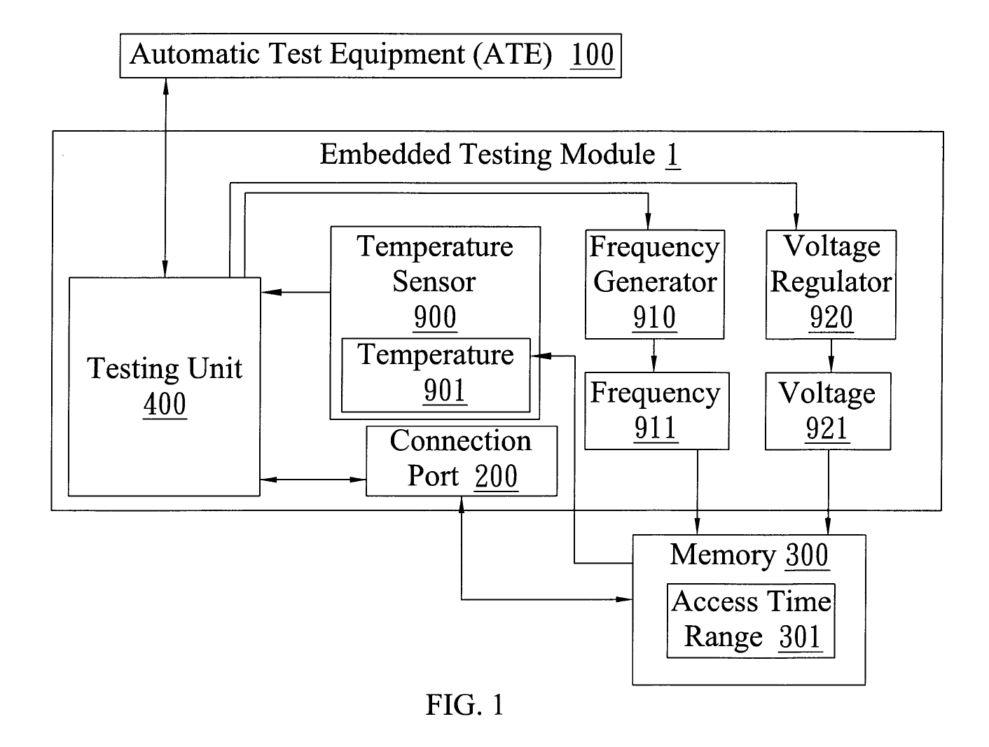

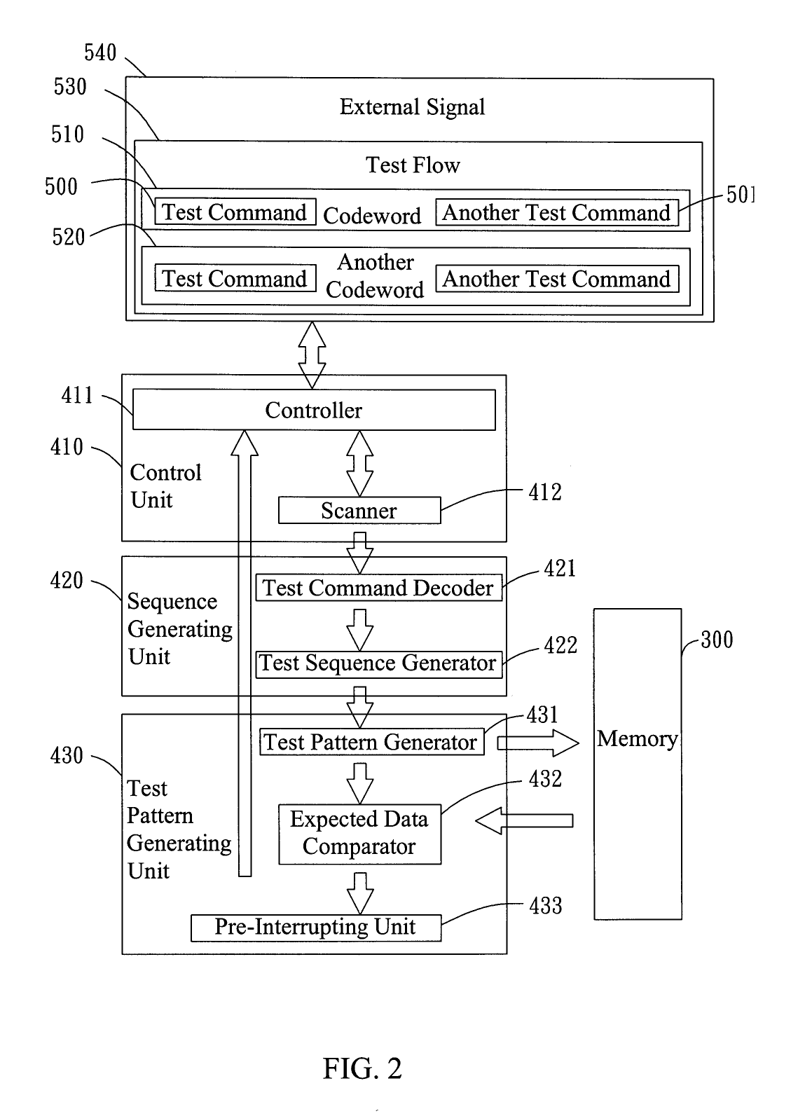

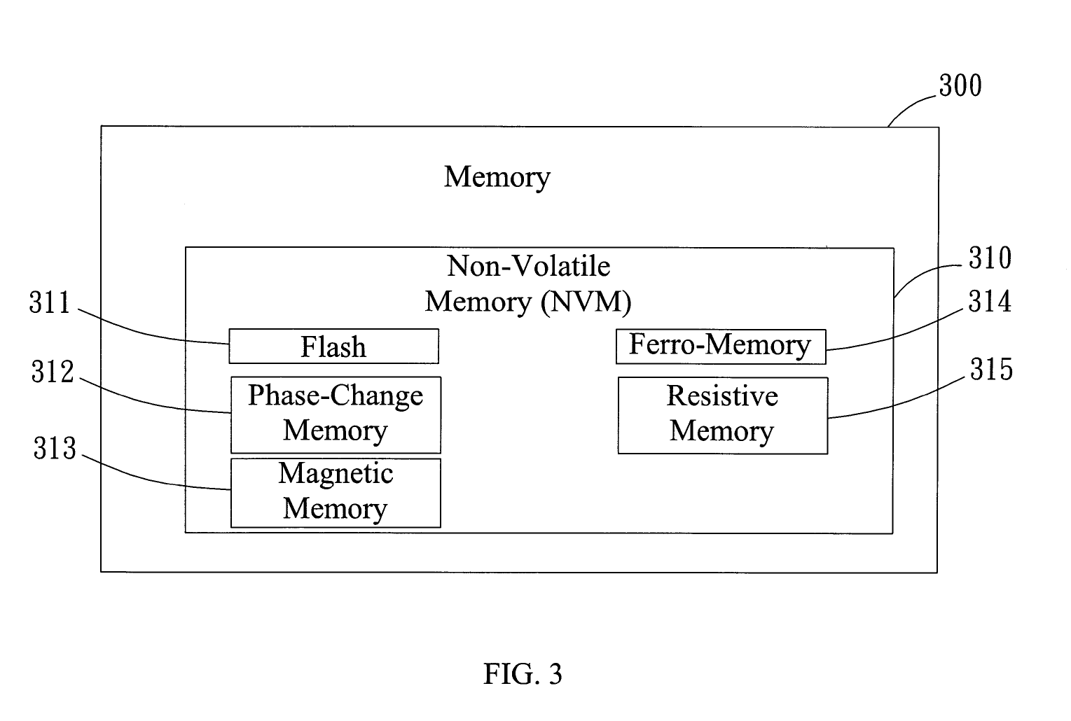

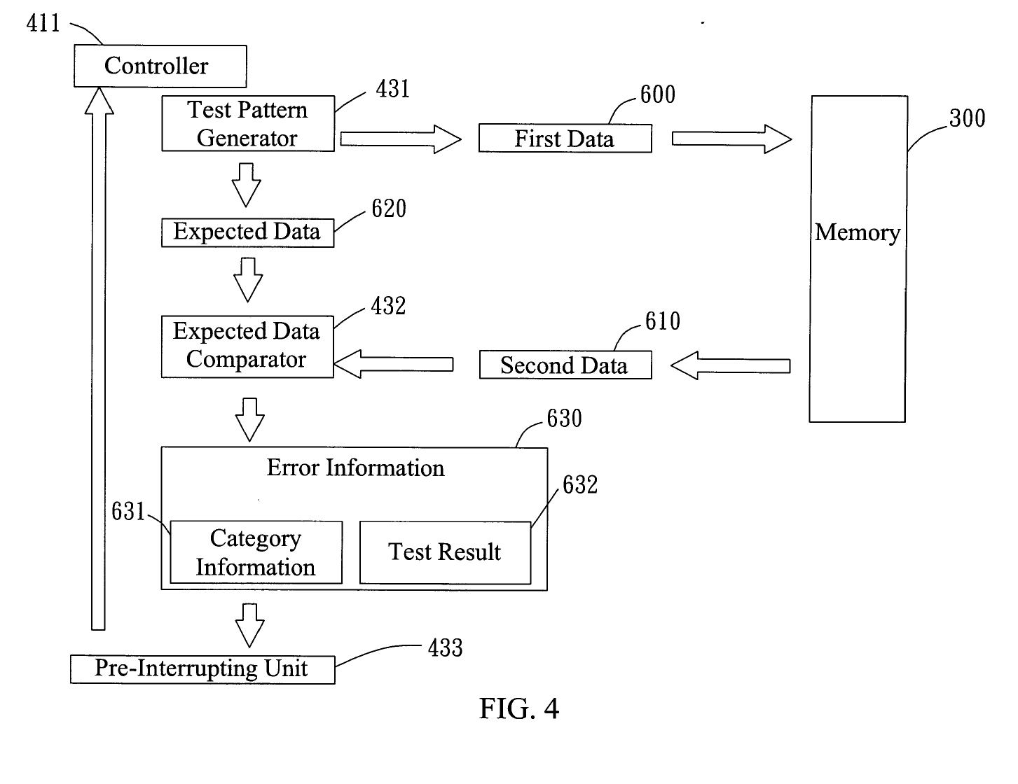

Refer initially to FIGS. 1 to 4, wherein FIG. 1 shows a first diagram for the embedded testing module according to the present invention, FIG. 2 shows a second diagram for the embedded testing module according to the present invention, FIG. 3 shows a diagram for the types of the memory under test which tested by the embedded testing module according to the present invention and FIG. 4 shows a third diagram for the embedded testing module according to the present invention. As depicted in FIGS. 1 to 4, the embedded testing module 1 according to the present invention comprises a connection port 200, a memory 300, a testing unit 400 and parameter generating and measuring units such as a temperature sensor 900, a frequency generator 910 and a voltage regulator 920. The memory 300 is used to store a first data 600, and the memory 300 is further tested based on the first data 600 to form a second data 610; more specifically, the first data 600 can be for example a test flow 530, and the second data 610 can be the result generated through the execution of the first data 600. Herein the memory 300 is electrically connected to the connection port 200 and transfers the first data 600 and the second data 610 by way of the connection port 200; besides, the memory 300 can be for example a FLASH 311, phase-change memory 312, magnetic memory 313, ferro-memory 314 or resistive memory 315. The testing unit 400 generates the first data 600 and an expected data 620 corresponding to the first data 600 by means of a test command 500 or another test command 501, wherein through the connection port 200 the testing unit 400 transfers the first data 600 to the memory 300 and receives the second data 610 from the memory 300 so as to compare the second data 610 with the expected data 620; if they do not match, an error information 630 can be immediately outputted to an external Automatic Test Equipment (ATE) 100, and the test can be for example aborted at the same time as the output of the error information 630 thus allowing the test operator to directly perform debug or correction processes, in which the error information 630 may include the category information 631 and the test result 632. The external ATE 100 can be for example an operation interface with a screen, allowing the user to issue the external test command 500 or alternatively to collect the error information 630 outputted by the testing unit 400. The test command 500 can be for example encoded as a codeword 510 along with another test command 501; that is, multiple frequently used test commands 500 can be collectively encoded as one single codeword 510 thereby saving the storage space for the test command 500. Once again, the codeword 510 can be further concatenated with another codeword 520 to form the test flow 530.

Additionally, in the embedded testing module 1 according to the present invention, the testing unit 400 can also comprise a control unit 410, a sequence generating unit 420 and a test pattern generating unit 430. The control unit 410 is used to control the operation of the testing unit 400 and receives the codeword 510, wherein the control unit 410 includes for example a controller 411 and a scanner 412, in which the controller 411 is used to receive an external signal 540 and determines and process the received external signal 540, which external signal 540 including such as the clock signal, selection signal, reset signal, control signal, pass signal, end signal, serial input, serial output and the like thereby controlling the operation of the testing unit 400; meanwhile, the external signal 540 includes the codeword 510 which, upon receiving the codeword 510 by the controller 411, can be transferred to the scanner 412; after reception of the complete codeword 510, the codeword 510 can be inputted to the sequence generating unit 420 one by one. The sequence generating unit 420 is used to decode the codeword 510 and generate a corresponding test flow 530, wherein the sequence generating unit 420 includes for example a test command decoder 421 and a test sequence generator 422, which test command decoder 421 being used to receive the codeword 510 outputted by the scanner 412 and decoding the codeword 510 into one or more test commands 500 thereby outputting to the test sequence generator 422; herein different test sequences can be generated by the test sequence generator 422 in accordance with different codeword 510 and then the test sequence generator 422 inputs the test sequence to the test pattern generating unit 430.

Furthermore, the test pattern generating unit 430 is used to convert the test flow 530 into the first data 600 verifiable by the memory 300 and generate the expected data 620 for comparison with the second data 610; when the memory 300 generates the second data 610 and transfers it back to the testing unit 400 over the connection port 200, the test pattern generating unit 430 compares the second data 610 with the expected data 620 for their consistency, and the test pattern generating unit 430 can include for example a test pattern generator 431, an expected data comparator 432 and a pre-interrupting unit 433. The test pattern generator 431 is used to receive the test sequence and convert it into the first data 600 required for the test on the memory 300, in which the first data 600 can be for example a clear instruction, a program instruction or a read instruction. The test pattern generating unit 430 transfers the first data 600 to the memory 300 and also generates the expected data 620 to the expected data comparator 432; after returning the second data 610 by the memory 300, the expected data comparator 432 compares the expected data 620 with the second data 610 so as to determine whether any error exists in the memory 300; if after comparison the expected data comparator 432 identifies that the expected data 620 does not match the second data 610, then the expected data comparator 432 transfers the error information 630 to the pre-interrupting unit 433 which in turn sends the error information 630 to the controller 411 such that the controller 411 immediately aborts the operations of the sequence generating unit 420 and the test pattern generating unit 430 and also transfers the error information 630 to the external ATE 100 so the test operator can be aware of the error information 630 concerning the memory 300.

Meanwhile, the embedded testing module 1 according to the present invention comprises for example a temperature sensor 900, a frequency generator 910 and a voltage regulator 920, in which the frequency generator 910 and the voltage regulator 920 are electrically connected to the memory 300 and the testing unit 400, the temperature sensor 900 is electrically connected to the testing unit 400, in which the temperature sensor 900 detects the temperature 901 in the memory 300, and the testing unit 400 sets the frequency 911 of the frequency generator 910 and the voltage 921 of the voltage regulator 920 based on the test command 500 such that the memory 300 operates under such a frequency 911 and a voltage 921. More specifically, the embedded testing module 1 according to the present invention can execute the function of parameter measurement on the memory 300 in conjunction with the temperature sensor 900, frequency generator 910 and voltage regulator 920 based on user's demands. After transferring the test command 500 with parametric measurements to the testing unit 400 from for example the ATE 100 by the test operator, the testing unit 400 sets respectively the frequency generator 910 and voltage regulator 920 based on the frequency 911 and the voltage 921 described in the test command 500 thereby allowing the memory 300 to operate at the requested working frequency 911 and voltage 921, and the testing unit 400 performs tests on the memory 300 according to the test flow 530 indicated in the codeword 510. Also, upon detecting the existence of error in the memory 300 by the embedded testing module 1, with the parametric test function, the frequency 911, voltage 921, temperature 901 or access time range 301 in the memory 300 configured at that time can be stored into the memory 300 for subsequent tracking processes by the test operator; besides, such a frequency 911, voltage 921, temperature 901 or access time range 301 can be outputted to the ATE 100 as well for further categorizations and error analyses by the test operator.

It should be noted that, those skilled ones in the art should appreciate that the implementation of categorizations and error analyses on the frequency, voltage, temperature or access time range illustrated in the present embodiment is merely an exemplary instance rather than restrictions. Hence, it is to be explicitly indicated beforehand that those skilled ones in the art can arbitrarily combine, disassemble or substitute the aforementioned function blocks.

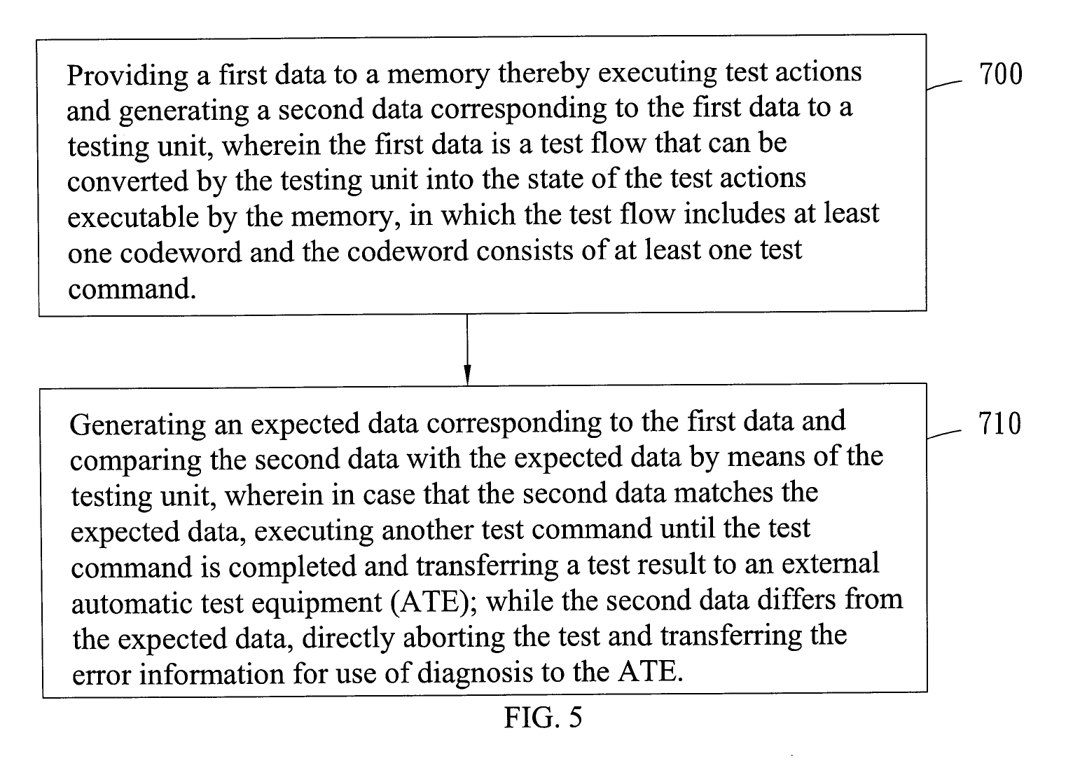

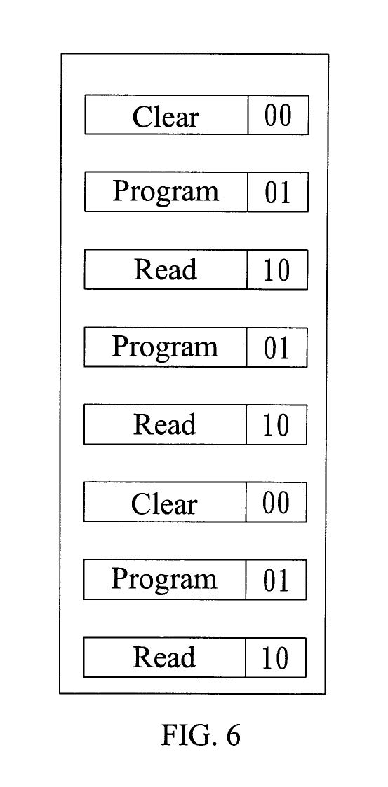

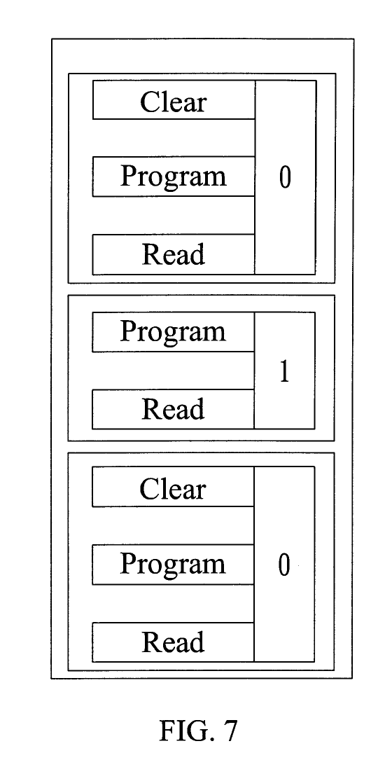

Next, with reference to FIG. 5, the present invention further provides a testing method of the embedded testing module, wherein a flowchart for a first embodiment of the testing method of the embedded testing module according to the present invention is shown. In STEP 700, the method comprises providing a first data to the memory thereby executing test actions and generating a second data corresponding to the first data to a testing unit, wherein the first data is a test flow that can be converted by the testing unit into the state of the test actions executable by the memory, in which the test flow includes at least one codeword and the codeword consists of at least one test command. In other word, the testing method of the embedded testing module according to the present invention applies the concatenation of codeword to constitute the test flow which allows reductions of storage space required for saving test commands; for example, refer conjunctively to FIGS. 6 and 7, wherein FIG. 6 shows a diagram for a conventional record test command and FIG. 7 shows a diagram for a record test command according to the present invention. Taking FIG. 6 as an example, in case of three test commands, each test command needs at least 2 bits for encoding, so, in terms of FIG. 6, sixteen bits are required for storing 8 test commands. Refer subsequently to FIG. 7, in which, by using the embedded testing module and testing method thereof, multiple test commands can be encoded as one codeword, thus only three bits suffice for storage for executing the same test commands.

In STEP 710, the method comprises generating an expected data corresponding to the first data and comparing the second data with the expected data by means of the testing unit, wherein in case that the second data matches the expected data, executing another test command until the test command is completed and transferring the test result to the testing unit; while the second data differs from the expected data, directly aborting the test and transferring the error information for use of testing to the testing unit. In brief, suppose that the second data generated by the memory mismatches the expected data, the testing unit can output the error information in no time to an external ATE and terminate the test flow, such that the test operator can immediately perform categorizations on the memory according to the types of errors with regards to the error information. Herein the error information may include such as the category information and the test result. It should be emphasized that, in the testing method of the embedded testing module according to the present invention, the test flow is formed by concatenating at least one codeword thereby reducing the storage space for saving the test commands, which is different from the conventional approach for constructing the test flow through individually inputting respective test command. Moreover, in the testing mode of the embedded testing module according to the present invention, it further comprises that when the testing unit finds the expected data differs from the second data, the test flow is aborted immediately which is also different from the conventional approach for not transferring the error information to the external ATE until tests of all test commands are completed.

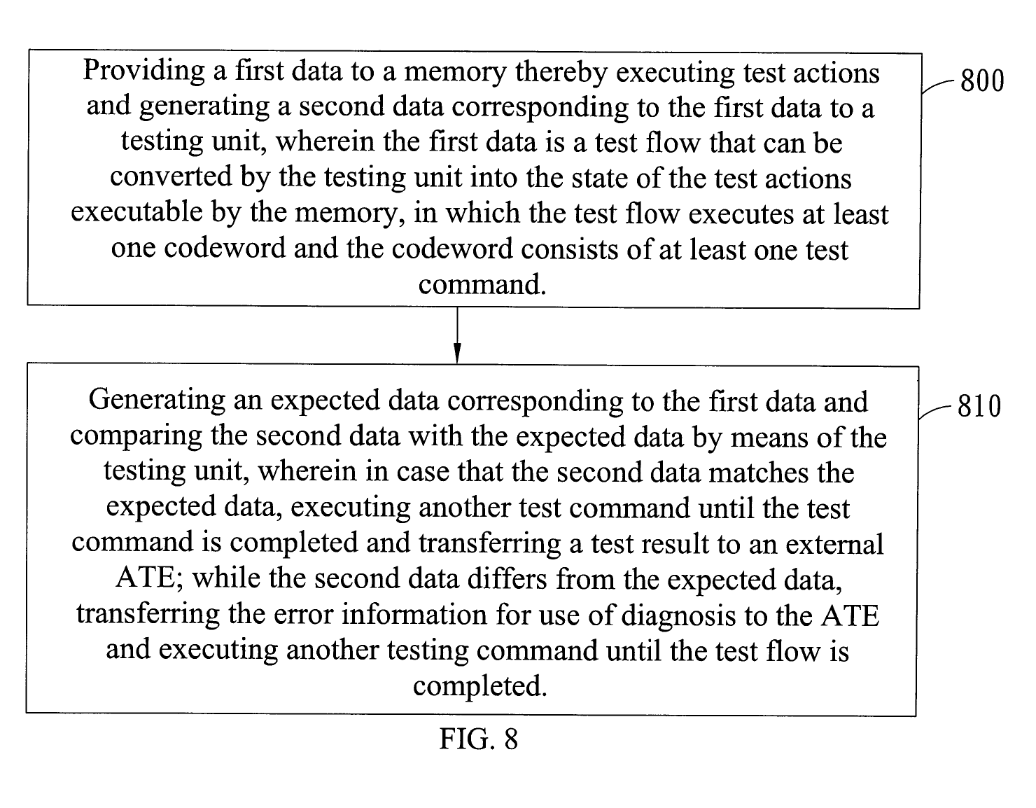

Next, with reference to FIG. 8, the present invention further provides a testing method of the embedded testing module, wherein a flowchart for a second embodiment of the testing method of the embedded testing module according to the present invention is shown. In FIG. 8, STEP 800 illustrates that the method comprises providing a first data to the memory thereby executing test actions and generating a second data corresponding to the first data to a testing unit, wherein the first data is a test flow that can be converted by the testing unit into the state of the test actions executable by the memory, in which the test flow executes at least one codeword and the codeword consists of at least one test command. The processes and characteristics of STEP 5800 in the second embodiment of the present invention are identical to the ones of STEP 700 in the first embodiment which are herein omitted for brevity.

In STEP 810, the method comprises generating an expected data corresponding to the first data and comparing the second data with the expected data by means of the testing unit, wherein in case that the second data matches the expected data, executing another test command until the test command is completed and transferring the test result to the testing unit; while the second data differs from the expected data, transferring the error information for use of testing to an external ATE and executing another testing command until the test flow is completed. In brief, the difference between the first and the second embodiments essentially lies in that, the test flow will not be terminated immediately even though the testing unit identifies that the second data mismatches the expected data, but instead it sends in real-time the error information to the external ATE, herein the error information includes the category information and the test result. It should be specifically emphasized that the difference between the second embodiment of the present invention and prior art technology mainly exists in that, except that the aforementioned test flow is constructed by concatenating at least one codeword so as to reduce the storage space for saving test commands, suppose the testing unit identifies multiple pairs of different second data and expected data, then a plurality of corresponding error information can be provided to the external ATE; comparatively, the conventional technology is incapable of offering relevant information about such occurrence points of errors which may undesirably lengthen time for test and debug processes.

The aforementioned descriptions are exemplary rather than being restrictive. All effectively equivalent changes, alternation or substitutions made thereto without departing from the spirit and scope of the present invention are deemed to be encompassed by the present invention as delineated in the following claims.

What is claimed is:

1. An embedded testing module, comprising:
a connection port;
a memory electrically connected to the connection port and used to store a first data, in which the memory is tested based on the first data so as to form a second data and transfers the second data through the connection port; and
a testing unit executing a test command or another test command to generate the first data and an expected data corresponding to the first data, in which the testing unit transfers the first data via the connection port to the memory and receives the second data through the connection port thereby comparing with the expected data, and in case the second data differs from the expected data, an error information can be immediately outputted to an external automatic test equipment (ATE), in which the test command and another test command are encoded as a codeword.

2. The embedded testing module according to claim 1, wherein the testing unit comprises a control unit, a sequence generating unit and a test pattern generating unit, in which the control unit controls the operations of the testing unit and receives the codeword, the sequence generating unit is used to decode the codeword and generate a corresponding test flow, and the test pattern generating unit is used to convert the test flow into the first data identifiable by the memory, generate the expected data and compare the second data with the expected data.

3. The embedded testing module according to claim 2, wherein the memory executes the test flow thereby forming the second data.

4. The embedded testing module according to claim 3, wherein, in case that the second data mismatches the expected data, the test flow is aborted.

5. The embedded testing module according to claim 2, wherein the control unit includes a controller and a scanner.

6. The embedded testing module according to claim 2, wherein the sequence generating unit includes a test command decoder and a test sequence generator.

7. The embedded testing module according to claim 2, wherein the test pattern generating unit includes a test pattern generator, an expected data comparator and a pre-interrupting unit.

8. The embedded testing module according to claim 2, further comprising a temperature sensor which is electrically connected to the testing unit and used to detect the temperature in the memory.

9. The embedded testing module according to claim 8, wherein the memory executes the test flow to form the second data, and in case that the second data mismatches the expected data, the temperature and an access time range of the memory are stored in the memory and outputted to the ATE for further categorizations and error analyses.

10. The embedded testing module according to claim 2, further comprising a frequency generator which is electrically connected to the memory and the testing unit, in which the testing unit sets a frequency for the frequency generator based on the testing command such that the memory operates at the assigned frequency.

11. The embedded testing module according to claim 10, wherein the memory executes the test flow to form the second data, and in case that the second data mismatches the expected data, the frequency and an access time range of the memory are stored in the memory and outputted to the ATE for further categorizations and error analyses.

12. The embedded testing module according to claim 2, further comprising a voltage regulator which is electrically connected to the memory and the testing unit, in which the testing unit sets a voltage for the voltage regulator based on the testing command such that the memory operates at the assigned voltage.

13. The embedded testing module according to claim 12, wherein the memory executes the test flow to form the second data, and in case that the second data mismatches the expected data, the voltage and an access time range of the memory are stored in the memory and outputted to the ATE for further categorizations and error analyses.

14. The embedded testing module according to claim 1, wherein the error information includes a category information and a test result, and the error information can be stored in the memory for record.

15. The embedded testing module according to claim 1, further comprising another codeword, in which the codeword and another codeword are concatenated to constitute a test flow.

16. The embedded testing module according to claim 1, wherein the memory is a Non-Volatile Memory (NVM).

17. A testing method of embedded testing module, comprising:
providing a first data to a memory thereby executing test actions and generating a second data corresponding to the first data to a testing unit, wherein the first data is a test flow that can be converted by the testing unit into the state of the test actions executable by the memory, in which the test flow includes at least one codeword and the codeword consists of at least one test command; and
generating an expected data corresponding to the first data and comparing the second data with the expected data by means of the testing unit, wherein in case that the second data matches the expected data, executing another test command until the test flow is completed and transferring a test result to an external automatic test equipment (ATE); while the second data differs from the expected data, directly aborting the test and transferring an error information for use of testing to the external ATE.

18. The testing method of embedded testing module according to claim 17, wherein the error information includes a category information and the test result and the error information can be stored in the memory for record.

19. A testing method of embedded testing module, comprising:
providing a first data to a memory thereby executing test actions and generating a second data corresponding to the first data to a testing unit, wherein the first data is a test flow that can be converted by the testing unit into the state of the test actions executable by the memory, in which the test flow includes at least one codeword and the codeword consists of at least one test command; and
generating an expected data corresponding to the first data and comparing the second data with the expected data by means of the testing unit, wherein in case that the second data matches the expected data, executing another test command until the test flow is completed and transferring a test result to an external automatic test equipment (ATE); while the second data differs from the expected data, transferring an error information for use of testing to the external ATE and executing another test command until the test flow is completed.

20. The testing method of embedded testing module according to claim 19, wherein the error information includes a category information and the test result, and the error information can be stored in the memory for record.
